(19) United States
(12) Patent Application Publication
(10) Pub. No.: US 2018/0196255 A1
(43) Pub. Date: Jul. 12, 2018

(54) DISPLAY DEVICE AND DRIVING METHOD THEREOF

(71) Applicant: BOE TECHNOLOGY GROUP CO., LTD., Beijing (CN)

(72) Inventors: Dongni LIU, Beijing (CN); Shengji YANG, Beijing (CN); Yafeng YANG, Beijing (CN); Xiaochuan CHEN, Beijing (CN)

(21) Appl. No.: 15/742,046

(22) PCT Filed: Feb. 13, 2017
(86) PCT No.: PCT/CN2017/073388

§ 371 Date: Jan. 5, 2018

(30) Foreign Application Priority Data
May 31, 2016 (CN) 201610377670.4

(51) Int. Cl. G02B 26/08; G02B 3/12; G02B 5/06

(52) U.S. Cl. CPC G02B 26/0875; G02B 5/06; G02B 3/12

(57) ABSTRACT

The present disclosure provides a display device and driving method thereof. The display device includes a display panel, a first optical unit and a second optical unit. The first optical unit is located at a light emerging side of the display panel, and the second optical unit is located at a light emerging side of the first optical unit. The first optical unit is configured to converge light emitted from the display panel to a convergent point, and the second optical unit is configured to convert the light emitted from the convergent point into emergent light and emit the emergent light, so that a display area of the display panel observed by human eyes through the emergent light is adjustable. In this way, the display PPI of the display panel observed by the human eyes is adjustable.

### CROSS-REFERENCE OF RELATED APPLICATION

The present invention is based on International Application No. PCT/CN2017/073388, filed on Feb. 13, 2017, which claims the benefits of Chinese patent application No. 201610377670.4 titled “DISPLAY DEVICE AND DRIVING METHOD THEREOF”, which was filed with the SIPO on May 31, 2016 and are fully incorporated herein by reference as part of this application.

### TECHNICAL FIELD

The present disclosure relates to the technical field of display technology, and particularly to a display device and driving method thereof.

### BACKGROUND

At present, liquid crystal display (LCD) devices with high resolution have been increasingly widely used, and a development thereof has drawn more and more attentions. However, with the increase of resolution, LCD displays are facing a series of issues. A decrease of pixel pitch of the LCD display requires thin film transistors (TFTs) and metal wires thinner, which, in turn, has extremely high requirements on the process technology which cannot be achieved by any existing manufacturing method. Additionally, although a size of the pixel is reduced, a light-blocking area of the TFT and the metal wire cannot be decreased proportionately; as a result, an aperture ratio of the pixel is smaller and smaller, which will certainly lead to increased power consumption and cost for the purpose of satisfying the demands on brightness.

In view of the problems above, it may be hard to increase a rude value of pixels per inch (PPI) in the existing LCD display, thereby resulting in the PPI of the LCD display nonadjustable.

### SUMMARY

The present disclosure provides a display device and driving method thereof, which enable the display PPI of the display panel observed by human eyes adjustable.

To achieve the objective above, the present disclosure provides a display device including a display panel, a first optical unit and a second optical unit. The first optical unit is located at a light emerging side of the display panel, and the second optical unit is located at a light emerging side of the first optical unit.

The first optical unit is configured to converge light emitted from the display panel to a convergent point.

The second optical unit is configured to convert the light emitted from the convergent point into emergent light and emit the emergent light, so that a display area of the display panel observed by human eyes through the emergent light is adjustable.

In an example of the embodiment, the second optical unit is a second convex lens unit, a convex surface of a cambered structure of the second convex lens unit is opposite to the display panel, and the convergent point is a focus point of the second convex lens unit.

In an example of the embodiment, a focal length of the second convex lens unit is determined by a sagitta (arch height) and a width of the second convex lens unit.

In an example of the embodiment, the second convex lens unit includes a liquid crystal convex lens or a convex lens film layer.

In an example of the embodiment, the first optical unit is a first convex lens unit, and a convex surface of a cambered structure of the first convex lens unit faces the display panel, and the convergent point is a focus point of the first convex lens unit.

In an example of the embodiment, the first convex lens unit includes a liquid crystal convex lens or a convex lens film layer.

In an example of the embodiment, the second optical unit is a second prism unit, a bevel face of a beveled structure in the second prism unit is opposite to the display panel, and the convergent point is a focus point of the second prism unit.

In an example of the embodiment, the second prism unit includes a liquid crystal prism or a prism film layer.

In an example of the embodiment, the first optical unit is a first prism unit, a bevel face of a beveled structure in the first prism unit faces the display panel, and the convergent point is a focus point of the first prism unit.

In an example of the embodiment, the first prism unit includes a liquid crystal prism or a prism film layer.

In an example of the embodiment, the display area of the display panel observed by human eyes is adjusted by an adjustment of a width of the second optical unit.

In an example of the embodiment, a focal length of the second optical unit is shorter than a focal length of the first optical unit.

In an example of the present embodiment, a width of the second optical unit is smaller than a width of the first optical unit.

To achieve the objective above, the present disclosure provides a method of driving a display device. The display device includes a display panel, a first optical unit and a second optical unit; the first optical unit is located at a light emerging side of the display panel, and the second optical unit is located at a light emerging side of the first optical unit. The method includes: converging light emitted from the display panel to a convergent point through the first optical unit; converting the light emitted from the convergent point into emergent light and emitting the emergent light through the second optical unit so that a display area of the display panel viewed by human eyes through the emergent light is adjustable.

In technical solutions of the display device and driving method thereof provided in some embodiments of the present disclosure, the first optical unit is located at a light emerging side of the display panel, and the second optical unit is located at a light emerging side of the first optical unit; the first optical unit converges the light emitted from the display panel to a convergent point; the second optical unit converts the light emitted from the convergent point into emergent light and emits the emergent light so that a display area of the display panel observed by human eyes through the emergent light is adjustable. In this way, the display PPI of the display panel observed by the human eyes is adjustable.

### BRIEF DESCRIPTION OF THE DRAWINGS

FIG. 1 is a structural schematic view of a display device provided by a first embodiment of the present disclosure;

FIG. 2 is a structural schematic view of a display device provided by a second embodiment of the present disclosure; and

FIG. 3 is a flow chart illustrating a method of driving a display device provided by a third embodiment of the present disclosure.

### DETAILED DESCRIPTION

Hereinafter, the display device and the method for driving the same provided by the present disclosure will be descried in more details with reference to the drawings so that those skilled in the art could understand the technical solutions of the present disclosure in a better way.

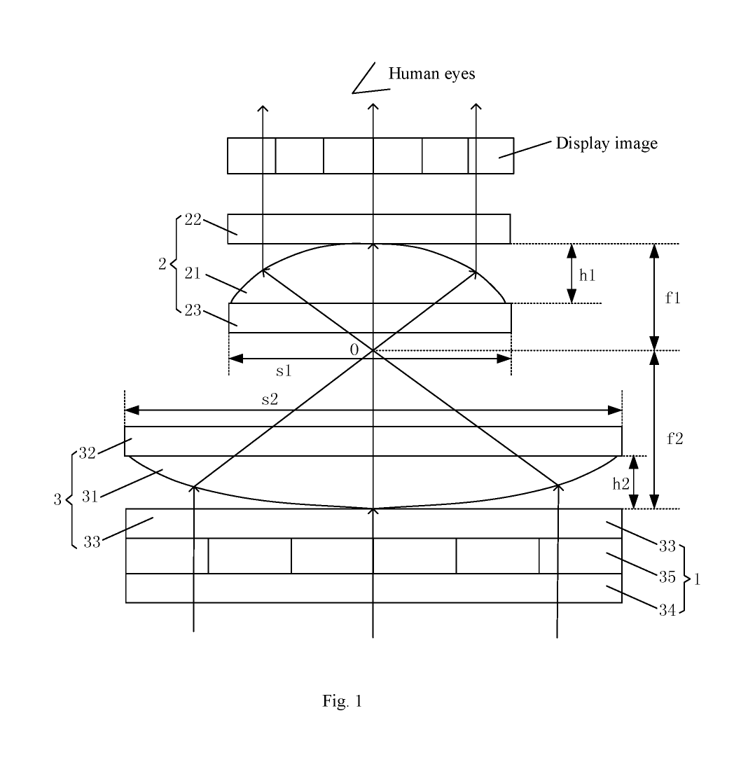

FIG. 1 is a structural schematic view of a display device provided by a first embodiment of the present disclosure. As illustrated in FIG. 1, the display device includes a display panel 1, a first optical unit and a second optical unit. The first optical unit is located at a light emerging side of the display panel 1, and the second optical unit is located at a light emerging side of the first optical unit. The first optical unit is configured to converge light emitted from the display panel 1 to a convergent point O, and the second optical unit is configured to convert the light emitted from the convergent point O into emergent light and emit the emergent light, so that a display area of the display panel observed by human eyes through the emergent light is adjustable.

In the present embodiment, the emergent light is parallel light.

In the present embodiment, the emergent light is emitted and enters human eyes so that the human eyes observe a display image on the display panel 1. As it can be seen from the figure, a display area of the display image is different from an initial display area of the display panel 1 in that: the display area of the display panel 1 observed by the human eyes is decreased. With the arrangement of the first optical unit and the second optical unit, it realizes an adjustable display area of the display panel observed by the human eyes.

The second optical unit is a second convex lens unit 2, a convex surface of a cambered structure 21 of the second convex lens unit 2 is opposite to the display panel 1, and the convergent point O is a focus point of the second convex lens unit 2. The second convex lens unit 2 may include a liquid crystal convex lens or a convex lens film layer. In the present embodiment, the second convex lens unit 2 is a liquid crystal convex lens. In the present embodiment, the second convex lens unit 2 may include a first substrate 22, a cambered structure 21 and a second substrate 23. The cambered structure 21 is located between the first substrate 22 and the second substrate 23, and a convex surface of the cambered structure 21 is opposite to the display panel 1. Liquid crystals are located between the first substrate 22 and the second substrate 23, and are formed into the cambered structure 21 when a preset voltage is applied between the first substrate 22 and the second substrate 23. For example, a focal length f1 of the second convex lens unit 2 may be determined by a sagitta (i.e., an arch height of the cambered structure 21) h1 and a width s1 of the second convex lens unit 2. The sagitta h1 of the second convex lens unit 2 is a sagitta h1 of the cambered structure 21 in the second convex lens unit 2. Optionally, in actual applications, the second convex lens unit 2 may also be a second prism unit; a bevel face of a beveled structure in the second prism unit is opposite to the display panel, and the convergent point is a focus point of the second prism unit. The second prism unit includes a liquid crystal prism or a prism film layer, which is not shown in the figures.

The first optical unit is a first convex lens unit 3, a convex surface of a cambered structure 31 in the first convex lens unit 3 faces the display panel 1, and the convergent point O is a focus point of the first convex lens unit 3. Thus, the focus point of the first convex lens unit 3 is consistent with the focus point of the second convex lens unit 2. The first convex lens unit 3 includes a liquid crystal convex lens or a convex lens film layer. In the present embodiment, the first convex lens unit 3 is a liquid crystal convex lens. In the present embodiment, the first convex lens unit 3 may include a third substrate 32, a cambered structure 31 and a fourth substrate 33. The cambered structure 31 is located between the third substrate 32 and the fourth substrate 33, and a convex surface of the cambered structure 31 faces the display panel 1. Liquid crystals are provided between the third substrate 32 and the fourth substrate 33, and are formed into the cambered structure 31 when a preset voltage is applied between the third substrate 32 and the fourth substrate 33. For example, a focal length f2 of the first convex lens unit 3 may be determined by a sagitta h2 and a width s2 of the first convex lens unit 3. The sagitta h2 of the first convex lens unit 3 is a sagitta h2 of the cambered structure 31 in the first convex lens unit 3.

The display panel 1 may include the fourth substrate 33, a fifth substrate 34 and a plurality of display units 35 disposed between the fourth substrate 33 and the fifth substrate 34. The display unit 35 may include an array structure, a color filter structure and a liquid crystal layer; the array structure and the fifth substrate 34 constitute an array substrate; the color filter structure and the fourth substrate 33 constitute the color filter substrate; the liquid crystal layer is located between the color filter substrate and the array substrate. In the present embodiment, the display unit 35 may be a red display unit, a green display unit or a blue display unit; and the red display unit, the green display unit and the blue display unit are arranged in sequence between the fourth substrate 33 and the fifth substrate 34. In the present embodiment, the first convex lens unit 3 and the display panel 1 share the fourth substrate 33 so as to simplify a structure of the display device and hence reduce the cost. In actual applications, the first convex lens unit 3 and the display panel 1 may not share a same substrate but are provided with separated substrates, and details of such case will not be described herein.

In an embodiment, a width of the second optical unit may be smaller than a width of the first optical unit. In the present embodiment, in the case where the second optical unit is a second convex lens unit 2 and the first optical unit is a first convex lens unit 1, the width s1 of the second convex lens unit 2 is smaller than the width s2 of the first convex lens unit 3.

In an embodiment, a focal length of the second optical unit may be smaller than a focal length of the first optical unit. In the present embodiment, when the second optical unit is a second convex lens unit 2, the convergent point O is a focal point of the second convex lens unit 2, and a focal length of the second convex lens unit 2 is f1. When the first optical unit is a first convex lens unit 3, the convergent point O is a focal point of the first convex lens unit 3, and a focal length of the first convex lens unit 3 is f2. In an embodiment, the focal length f1 of the second convex lens unit 2 is smaller than the focal length f2 of the first convex lens unit 3 so as to ensure that all the light emitted from the display panel 1 can pass through the convergent point O and then irradiate onto the second convex lens unit 2, which allows the human eyes to observe complete display information on the display panel 1.

In the present embodiment, the display area of the display panel 1 observed by the human eyes may be adjusted by adjusting the width of the second optical unit. For example, by adjusting the width of the second optical unit, the display area of the display panel observed by the human eyes may be decreased. In the present embodiment, when the second optical unit is a second convex lens unit 23, the display area of the display panel observed by the human eyes may be adjusted by adjusting the width s1 of the second convex lens unit 2, for example, adjusting the display area of the display panel observed by the human eyes to be reduced. In particular, the focal length f1 of the second convex lens unit 2 may be adjusted by adjusting the width s1 of the second convex lens unit 2 so as to achieve the objective of adjusting the display area of the display panel 1 observed by the human eyes.

In the present embodiment, the structure of the display panel 1 is not changed, so do the TFTs and the metal wires in the display panel 1, and therefore, the display resolution and the initial PPI of the display panel 1 are not changed. In the present embodiment, the light emerging side of the display panel 1 is provided with the first convex lens unit 3 and the second convex lens unit 2 in sequence so that the emergent light emitted from the second convex lens unit 2 enters the human eyes, which allows the display area of the display panel 1 observed by the human eyes through the emergent light to be decreased. Due to the decrease of the display area observed by the human eyes, the display PPI of the display panel observed by the human eyes is increased, and hence the display image of the display panel observed by the human eyes is more accurate and finer, and thus the viewing effects are improved. Due to the reduction of the display area of the display panel 1 observed by the human eyes, a light-blocking area of the TFTs and the metal wires observed by the human eyes is decreased proportionately, and thereby as compared to conventional high-PPI products, the aperture ratio of the pixel is increased.

In the display device provided by the present embodiment, the first optical unit is located at the light emerging side of the display panel and the second optical unit is located at the light emerging side of the first optical unit. The first optical unit is configured to converge the light emitted from the display panel to a convergent point, and the second optical unit is configured to convert the light emitted from the convergent point into emergent light and emit the emergent light, so that a display area of the display panel viewed by human eyes through the emergent light is adjustable, thereby allowing the display PPI of the display panel observed by the human eyes adjustable. In the present embodiment, the first convex lens unit and the second convex lens unit may decrease the display area of the display panel observed by the human eyes, and hence improve the display PPI of the display panel observed by the human eyes. The technical solution of the present embodiment improves the PPI, so that the display device is applicable in high-PPI products or near-to-eye products. The present embodiment increases the display PPI and the display aperture ratio, thereby improving the display effects. The technical solution of the present embodiment can improve the display PPI without any need of modifying the structure of the display panel, and hence reduce the manufacturing cost.

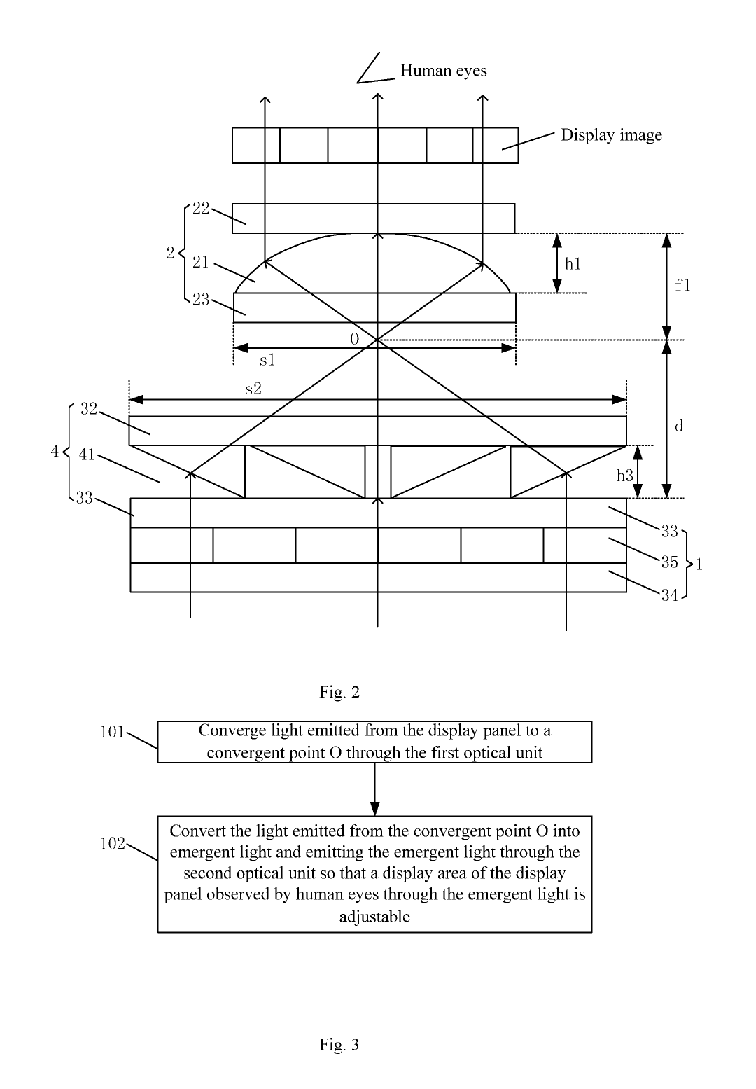

FIG. 2 is a structural schematic view of a display device provided by a second embodiment of the present disclosure. As illustrated in FIG. 2, the display device includes a display panel 1, a first optical unit and a second optical unit. The first optical unit is located at a light emerging side of the display panel 1, and the second optical unit is located at a light emerging side of the first optical unit. The first optical unit is configured to converge light emitted from the display panel 1 to a convergent point O, and the second optical unit is configured to convert the light emitted from the convergent point O into emergent light and emit the emergent light, so that a display area of the display panel observed by human eyes through the emergent light is adjustable.

In the present embodiment, the emergent light is parallel light.

In the present embodiment, the emergent light is emitted and enters human eyes so that the human eyes observe a display image of the display panel 1. As it can be seen from the figure, a display area of the display image is different from an initial display area of the display panel 1 in that: the display area of the display panel 1 observed by the human eyes is decreased. With the arrangement of the first optical unit and the second optical unit, it is provided with an adjustable display area of the display panel observed by the human eyes.

The second optical unit is a second convex lens unit 2, a convex surface of a cambered structure 21 in the second convex lens unit 2 is opposite to the display panel 1, and the convergent point O is a focus point of the second convex lens unit 2. The second convex lens unit 2 may include a liquid crystal convex lens or a convex lens film layer. In the present embodiment, the second convex lens unit 2 is a liquid crystal convex lens. In the present embodiment, the second convex lens unit 2 may include a first substrate 22, a cambered structure 21 and a second substrate 23. The cambered structure 21 is located between the first substrate 22 and the second substrate 23, and a convex surface of the cambered structure 21 is opposite to the display panel 1. Liquid crystals are provided between the first substrate 22 and the second substrate 23, and are formed into the cambered structure 21 when a preset voltage is applied between the first substrate 22 and the second substrate 23. In an embodiment, a focal length f1 of the second convex lens unit 2 may be determined by a sagitta h1 and a width s1 of the second convex lens unit 2. The sagitta h1 of the second convex lens unit 2 is a sagitta h1 of the cambered structure 21 in the second convex lens unit 2. Optionally, in actual applications, the second convex lens unit may also be a second prism unit, and a bevel face of a beveled structure in the second prism unit is opposite to the display panel. The second prism unit includes a liquid crystal prism or a prism film layer, without going into details herein.

The first optical unit is a first prism unit 4, a bevel face of a beveled structure 41 in the first prism unit 4 faces the display panel 1, and the convergent point O is a focus point of the first prism unit 4. Thus, the focus point of the first prism unit 4 is consistent with the focus point of the second convex lens unit 2. The first prism unit 4 includes a liquid crystal prism or a prism film layer. In the present embodiment, the first prism unit 4 is a liquid crystal prism. In the present embodiment, the first prism unit 4 may include a third substrate 32, a beveled structure 41 and a fourth substrate 33. The beveled structure 41 is located between the third substrate 32 and the fourth substrate 33, and a bevel face of the beveled structure 41 faces the display panel 1. Liquid crystals are provided between the third substrate 32 and the fourth substrate 33, and are formed into the beveled structure 41 when a preset voltage is applied between the third substrate 32 and the fourth substrate 33. A plurality of beveled structure 41 may be disposed, and the plurality of beveled structures 41 may be symmetrically arranged with respect to a central line of the display panel 1 as a reference. The bevel faces of the beveled structures 41 located at both sides of the central line are all inclined away from the central line.

The display panel 1 may include the fourth substrate 33, a fifth substrate 34 and a plurality of display units 35 disposed between the fourth substrate 33 and the fifth substrate 34. The display unit 35 may include an array structure, a color filter structure and a liquid crystal layer. The array structure and the fifth substrate 34 constitute an array substrate; the color filter structure and the fifth substrate 34 constitute the color filter substrate; and the liquid crystal layer is located between the color filter substrate and the array substrate. In the present embodiment, the display unit 35 may be a red display unit, a green display unit or a blue display unit, and the red display unit, the green display unit and the blue display unit are arranged in sequence between the fourth substrate 33 and the fifth substrate 34. In the present embodiment, the first prism unit 4 and the display panel 1 share the fourth substrate 33 so as to simplify a structure of the display device and hence reduce the cost. In actual applications, the first prism unit 4 and the display panel 1 may not share a same substrate but are provided with separated substrates, without going into details herein.

In an embodiment, a width of the second optical unit is smaller than a width of the first optical unit. In the present embodiment, in the case where the second optical unit is a second convex lens unit 2 and the first optical unit is a first convex lens unit 3, the width s1 of the second convex lens unit 2 is smaller than the width s2 of the first convex lens unit 3.

In an embodiment, a focal length of the second optical unit is smaller than a focal length of the first optical unit. In the present embodiment, when the second optical unit is a second convex lens unit 2, the convergent point O is a focal point of the second convex lens unit 2, and a focal length of the second convex lens unit 2 is f1. When the first optical unit is a first prism unit 4, a focal length of the first prism unit 4 is d. The focal length f1 of the second convex lens unit 2 may be smaller than the focal length d of the first prism unit 4 so as to ensure that all the light emitted from the display panel 1 can pass through the convergent point O and then irradiate onto the second convex lens unit 2, which allows the human eyes to observe complete display information on the display panel 1.

In the present embodiment, the display area of the display panel 1 observed by the human eyes is adjusted by an adjustment of the width of the second optical unit. For example, by adjusting the width of the second optical unit, the display area of the display panel observed by the human eyes can be decreased. In the present embodiment, when the second optical unit is a second convex lens unit 2, the display area of the display panel observed by the human eyes can be adjusted by adjusting the width s1 of the second convex lens unit 2, for example, adjusting the display area of the display panel observed by the human eyes to be reduced. In particular, the focal length f1 of the second convex lens unit 2 may be adjusted by adjusting the width s1 of the second convex lens unit 2 so as to achieve the objective of adjusting the display area of the display panel 1 observed by the human eyes.

In the present embodiment, the structure of the display panel 1 is not changed, so do the TFTs and the metal wires in the display panel 1. As a result, the display resolution and the initial PPI of the display panel 1 are not changed. In the present embodiment, the light emerging side of the display panel 1 is provided with the first prism unit 4 and the second convex lens unit 2 in sequence so that the emerging light emitted from the second convex lens unit 2 enters the human eyes, which allows the display area of the display panel 1 observed by the human eyes through the emergent light to be decreased. Due to the decrease of the display area observed by the human eyes, the display PPI of the display panel observed by the human eyes is reduced, and hence the display image of the display panel observed by the human eyes is more accurate and finer, and thus improves the viewing effect. Due to the reduction of the display area of the display panel 1 observed by the human eyes, a light-blocking area of the TFT and the metal wire observed by the human eyes is decreased proportionately, thereby increasing the aperture ratio of the pixel as compared to conventional high-PPI products.

In the display device provided by the present embodiment, the first optical unit is located at the light emerging side of the display panel and the second optical unit is located at the light emerging side of the first optical unit, wherein the first optical unit is configured to converge the light emitted from the display panel to a convergent point, and the second optical unit is configured to convert the light emitted from the convergent point into emergent light and emit the emergent light, so that a display area of the display panel observed by human eyes through the emergent light is adjustable, thereby allowing the display PPI of the display panel observed by the human eyes adjustable. In the present embodiment, the first prism unit and the second convex lens unit may decrease the display area of the display panel observed by the human eyes, and hence improve the display PPI of the display panel observed by the human eyes. The technical solution of the present embodiment improves the PPI, so that the display device is applicable in high-PPI products or near-to-eye products. The technical solution of the present embodiment increases the display PPI and the display aperture ratio, thereby improving the display effect. The technical solution of the present embodiment can improve the display PPI without any need of modifying the structure of the display panel, and hence reduce the manufacturing cost.

FIG. 3 is a flow chart illustrating a method of driving a display device provided by a third embodiment of the present disclosure. As illustrated in FIG. 3, the display device includes a display panel, a first optical unit and a second optical unit; the first optical unit is located at a light emerging side of the display panel, and the second optical unit is located at a light emerging side of the first optical unit.

The method includes: step S101, converging light emitted from the display panel to a convergent point O through the first optical unit; and S102, converting the light emitted from the convergent point O into emergent light, and emitting the emergent light through the second optical unit, so that a display area of the display panel observed by human eyes through the emergent light is adjustable.

In the method provided by the present embodiment, the first optical unit is located at the light emerging side of the display panel and the second optical unit is located at the light emerging side of the first optical unit; the first optical unit converges the light emitted from the display panel to a convergent point, and the second optical unit converts the light emitted from the convergent point into emergent light and emits the emergent light, so that a display area of the display panel observed by human eyes through the emergent light is adjustable, thereby allowing the display PPI of the display panel observed by the human eyes adjustable.

It should be understood that the foregoing implementations are merely illustrative embodiments for describing the principles of the present disclosure without limiting the present disclosure thereto. For those skilled in the art, various modifications and improvements may be made without departing from the scope and sprint of the present disclosure, which modifications and improvements shall also be fallen within the scope of protection of the present disclosure.

1. A display device, comprising a display panel, a first optical unit located at a light emerging side of the display panel, and a second optical unit located at a light emerging side of the first optical unit, wherein,
the first optical unit is configured to converge light emitted from the display panel to a convergent point, and
the second optical unit is configured to convert the light emitted from the convergent point into emergent light and to emit the emergent light so that a display area of the display panel observed by human eyes through the emergent light is adjustable.

2. The display device according to claim 1, wherein the second optical unit is a second convex lens unit, a convex surface of a cambered structure of the second convex lens unit is opposite to the display panel, and the convergent point is a focus point of the second convex lens unit.

3. The display device according to claim 2, wherein a focal length of the second convex lens unit is determined by a sagitta in a direction that is perpendicular to the display panel and a width in a direction that is parallel to the display panel of the second convex lens unit.

4. The display device according to claim 2, wherein the second convex lens unit comprises a liquid crystal convex lens or a convex lens film layer.

5. The display device according to claim 1, wherein the first optical unit is a first convex lens unit, a convex surface of a cambered structure of the first convex lens unit faces the display panel, and the convergent point is a focus point of the first convex lens unit.

6. The display device according to claim 5, wherein the first convex lens unit comprises a liquid crystal convex lens or a convex lens film layer.

7. The display device according to claim 1, wherein the second optical unit is a second prism unit, a bevel face of a beveled structure of the second prism unit is opposite to the display panel, and the convergent point is a focus point of the second prism unit.

8. The display device according to claim 7, wherein the second prism unit comprises a liquid crystal prism or a prism film layer.

9. The display device according to claim 1, wherein the first optical unit is a first prism unit, a bevel face of a beveled structure of the first prism unit faces the display panel, and the convergent point is a focus point of the first prism unit.

10. The display device according to claim 9, wherein the first prism unit comprises a liquid crystal prism or a prism film layer.

11. The display device according to claim 1, wherein the display area of the display panel observed by human eyes is adjusted by adjusting a width of the second optical unit which is in a direction that is parallel to the display panel.

12. The display device according to claim 1, wherein a focal length of the second optical unit is shorter than a focal length of the first optical unit.

13. The display device according to claim 1, wherein a width of the second optical unit which is in a direction that is parallel to the display panel is smaller than a width of the first optical unit which is in a direction that is parallel to the display panel.

14. A method for driving a display device, the display device comprising a display panel, a first optical unit located at a light emerging side of the display panel and a second optical unit located at a light emerging side of the first optical unit, the method comprising:
converging light emitted from the display panel to a convergent point through the first optical unit; and
converting the light emitted from the convergent point into emergent light and emitting the emergent light through the second optical unit so that a display area of the display panel observed by human eyes through the emergent light is adjustable.

15. The method according to claim 14, further comprising adjusting the display area of the display panel observed by human eyes by adjusting a width of the second optical unit.

16. The display device according to claim 6, wherein the second convex lens unit comprises a liquid crystal convex lens or a convex lens film layer.
